(19) United States
(12) Patent Application Publication
(10) Pub. No.: US 2010/0051475 A1
(43) Pub. Date: Mar. 4, 2010

(54) MACHINING ELECTRODE, ELECTROCHEMICAL MACHINING APPARATUS, ELECTROCHEMICAL MACHINING METHOD AND METHOD FOR MANUFACTURING STRUCTURE BODY

(75) Inventors: Hideo ETO, Kanagawa-ken (JP); Shuichi Saito, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/551,948

(22) Filed: Sep. 1, 2009

(30) Foreign Application Priority Data
Sep. 2, 2008 (JP) 2008-224531

(51) Int. Cl. B23H 7/22; B23H 7/26; B23H 7/14; C25F 3/00

(52) U.S. Cl. 205/674; 204/288.1; 204/219; 204/230.2; 205/640

(57) ABSTRACT

A machining electrode includes: a base substance including an electrolytic portion faced to a workpiece on one end face in an axial direction and having conductivity; an insulating unit provided on a face in a direction generally orthogonal to the axial direction of the base substance and having insulation; and a shielding unit provided on a face opposite to the base substance of the insulating unit.

### CROSS-REFERENCE TO RELATED APPLICATIONS

This application is based upon and claims the benefit of priority from the prior Japanese Patent Application No. 2008-224531, filed on Sep. 2, 2008; the entire contents of which are incorporated herein by reference.

### BACKGROUND OF THE INVENTION

1. Field of the Invention

This invention relates to a machining electrode, an electrochemical machining apparatus, an electrochemical machining method and a method for manufacturing a structure body.

2. Background Art

An electrochemical machining method has been known as a technique for forming unevenness on a surface of a structure body. The electrochemical machining method is a machining method where a machining electrode having a shape in accordance with a machining shape is faced to a surface of a workpiece in electrolytic solution, and electrolytic reaction is caused by applying voltage between the machining electrode and the workpiece to dissolve the surface of the workpiece electrochemically.

Recently, this electrochemical machining method has been used as a technique for forming fine unevenness of the structure body surface in manufacturing a dynamical pressure bearing of a hard disk driving device, wiring of a flat panel display and a semiconductor device or the like.

Here, it is necessary to prevent a portion other than a desired region from being dissolved electrochemically in order to form the fine unevenness with a high machining accuracy on the structure body surface. For that, JP-A 2006-239803(Kokai) discloses a technique covering the surface other than the portion (hereinafter referred to as an electrolytic portion) faced to the workpiece of a base substance provided on the machining electrode with insulator.

According to this disclosed technique, occurrence of a stray current and transmission current can be prevented to improve the machining accuracy. However, further improvement of the machining accuracy is desired under a recent circumstance of downsizing progress.

### SUMMARY OF THE INVENTION

According to an aspect of the invention, there is provided a machining electrode including: a base substance including an electrolytic portion faced to a workpiece on one end face in an axial direction and having conductivity; an insulating unit provided on a face in a direction generally orthogonal to the axial direction of the base substance and having insulation; and a shielding unit provided on a face opposite to the base substance of the insulating unit.

According to another aspect of the invention, there is provided an electrochemical machining apparatus including: a power supply; an electrolytic cell configured to store an electrolytic solution; a placement stage provided inside the electrolytic cell and configured to place the workpiece; a machining electrode provided opposed to the placement stage, the machining electrode including: a base substance including an electrolytic portion faced to a workpiece on one end face in an axial direction and having conductivity;-an insulating unit provided on a face in a direction generally orthogonal to the axial direction of the base substance and having insulation; and a shielding unit provided on a face opposite to the base substance of the insulating unit; and a moving mechanism configured to move the machining electrode.

According to another aspect of the invention, there is provided an electrochemical machining method, including causing an electrolytic reaction by applying voltage between a machining electrode and a workpiece in an electrolytic solution, and machining a surface of the workpiece, the machining electrode being provided with a base substance including an electrolytic portion faced to the workpiece on one end face in an axial direction, an insulating unit provided on a face in a direction generally orthogonal to the axial direction of the base substance and having insulation, and a shielding unit provided on a face opposite to the base substance of the insulating unit, and potential of the workpiece and the shielding unit being generally the same.

According to another aspect of the invention, there is provided a method for manufacturing a structure body, including forming unevenness on a workpiece using a electrochemical machining method, the electrochemical machining method including: causing an electrolytic reaction by applying voltage between a machining electrode and a workpiece in an electrolytic solution, and machining a surface of the workpiece, the machining electrode being provided with a base substance including an electrolytic portion faced to the workpiece on one end face in an axial direction, an insulating unit provided on a face in a direction generally orthogonal to the axial direction of the base substance and having insulation, and a shielding unit provided on a face opposite to the base substance of the insulating unit, and potential of the workpiece and the shielding unit being generally the same.

### BRIEF DESCRIPTION OF THE DRAWINGS

FIG. 1 is a schematic cross-sectional view for illustrating a machining electrode according to this embodiment;

FIG. 2 is a schematic cross-sectional view for illustrating a machining electrode according to a comparative example;

FIGS. 3A to 3C are schematic views for illustrating simulation results on a distribution of dielectric flux density;

FIGS. 4A to 4C are schematic views for illustrating simulation results on a distribution of dielectric flux density;

FIGS. 5A to 5C are schematic views for illustrating simulation results on a distribution of dielectric flux density in the machining electrode according to this embodiment;

FIGS. 6A to 6C are schematic plan views for illustrating a patterned portion of a workpiece;

FIGS. 7A and 7B are schematic views for illustrating a contamination on the machining electrode and a surface condition of the patterned portion;

FIGS. 8A and 8B are schematic views for illustrating the surface condition of the patterned portion;

FIGS. 9A and 9B are schematic cross-sectional views for illustrating an electrochemical machining apparatus according to this embodiment; and

FIGS. 10A to 10C are schematic cross-sectional views for illustrating a shape of electrolytic portion.

### DETAILED DESCRIPTION OF THE INVENTION

Embodiments of the invention will now be described with reference to the drawings. In the drawings, like elements are labeled with like reference numerals and the detailed description thereof will be appropriately omitted.

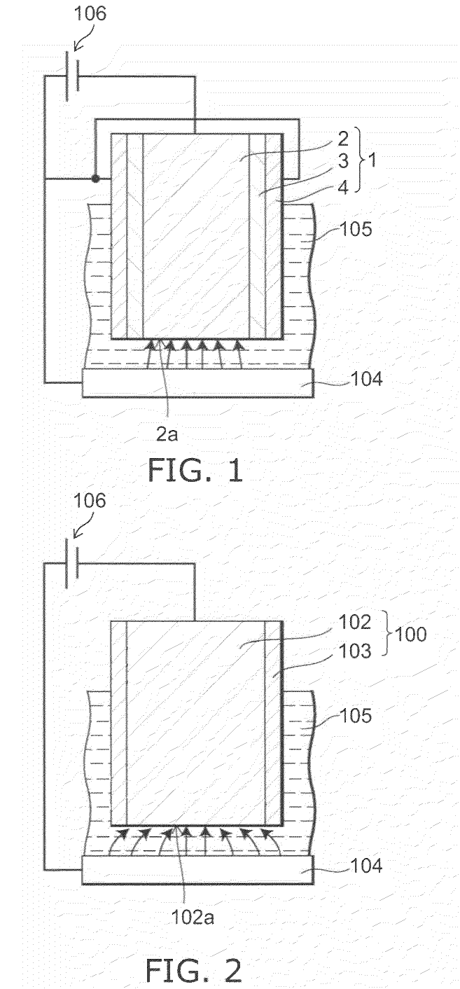

FIG. 1 is a schematic cross-sectional view for illustrating a machining electrode according to this embodiment.

FIG. 2 is a schematic cross-sectional view for illustrating a machining electrode according to a comparative example.

First, a machining electrode 100 according to the comparative example is illustrated.

As shown in FIG. 2, the machining electrode 100 is provided with a base substance 102 and an insulating unit 103. A cross-sectional shape and a cross-sectional dimension of the base substance 102 are accordance with a shape and a dimension of a processed portion of a workpiece 104.

The base substance 102 includes an electrolytic portion 102a faced to the workpiece 104 on one end face in an axial direction. The base substance 102 is formed from materials having conductivity. For instance, it can be formed from metal materials or the like. The metal materials are not particularly limited, but materials with a good corrosion resistance are preferably selected in consideration of dipping into an electrolytic solution 105. Such materials can illustratively include platinum, stainless steel or the like. However, the materials are not limited thereto, but can be changed appropriately.

A portion dipped into the electrolytic solution 105, namely, a surface of the base substance 102 other than the electrolytic portion 102a (portion faced to pattern the workpiece 104) is covered with the insulating unit 103 having insulation. That is, the insulating unit 103 having insulation is provided on a face in a direction generally orthogonal to the axial direction of the base substance 102. Materials for the insulating unit 103 are not particularly limited, but can be based on an epoxy based resin, an urethane based resin and a polyimide based resin in consideration of breakdown voltage in electrochemical machining, a corrosion resistance to the electrolytic solution 105, and a low dielectric constant. However, the materials are not limited thereto, but can be changed appropriately.

One end of the machining electrode 100 is dipped into the electrolytic solution 105 and the electrolytic portion 102a is faced to the surface of the workpiece 104. An end face on a side opposed to the electrolytic portion 102a of the base substance 102 is electrically connected to a cathode side of a power supply 106 for applying direct current voltage. An anode side of the power supply 106 is electrically connected to the workpiece 104. Voltage can be applied between the machining electrode 100 (base substance 102) and the workpiece 104. Hence, the electrolytic reaction can be caused between the electrolytic portion 102a and a patterned portion of the workpiece 104, and thus the surface of the workpiece 104 can be dissolved electrochemically to be patterned in a desired shape.

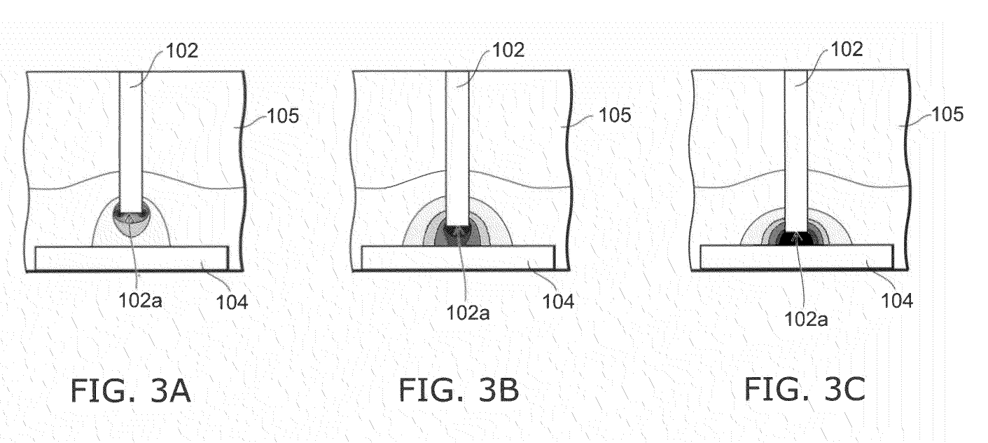

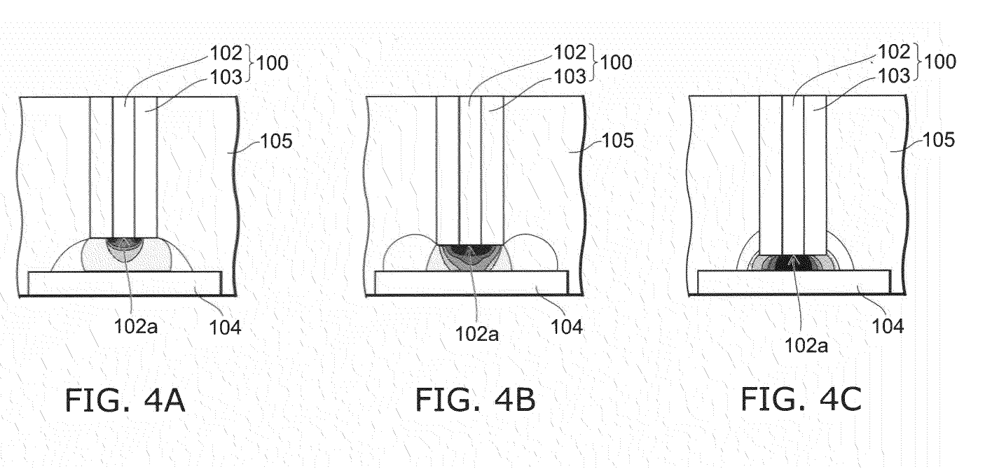

FIGS. 3A to 4C are schematic views for illustrating simulation results on a distribution of dielectric flux density.

FIGS. 3A to 3C are schematic views for illustrating the case of the machining electrode not provided with the insulating unit (machining electrode made of only the base substance 102). In this case, a diameter of the machining electrode (base substance 102) is set to be 5 mm. FIGS. 4A to 4C are schematic views for illustrating the case of the machining electrode 100 provided with the insulating unit 103 (the case illustrated in FIG. 2). In this case, the diameter of the base substance 102 is set to be 5 mm, and a thickness of the insulating unit 103 is set to be 5 mm. FIGS. 3A and 4A, FIGS. 3B and 4B, and FIGS. 3C and 4C illustrate cases where a distance between the electrolytic portion 102a and the workpiece 104 is changed, and the distance is set to be 15 mm for FIGS. 3A and 4A, 10 mm for FIGS. 3B and 4B, and 5 mm for FIGS. 3C and 4C.

FIGS. 3A to 3C and FIGS. 4A to 4C show simulation results of broadening of the dielectric flux density, its intensity shown by light and shade of a monotone color, and as the dielectric flux density becomes higher, the monotone color becomes denser, and the lower, the lighter.

As shown in FIGS. 3A to 3C, when the insulating unit is not provided on the machining electrode, that is, the machining electrode is made of only the base substance 102, the broadening of the dielectric flux density becomes larger. In this case, even if the distance between the electrolytic portion 102a and the workpiece 104 is changed as shown in FIGS. 3A to 3C, the broadening of the dielectric flux density cannot be prevented. Hence, the portion other than the desired region is dissolved electrochemically and thus the machining accuracy may deteriorate.

In contrast, as shown in FIGS. 4A to 4C, when the machining electrode 100 provided with the insulating unit 103 is used, the broadening of the dielectric flux density can be prevented. As shown in FIGS. 4A to 4C, changing the distance between the electrolytic portion 102a and the workpiece 104 can prevent the broadening of the dielectric flux density. Hence, the portion other than the desired portion can be prevented from being dissolved electrochemically, and thus the machining accuracy can be improved.

However, further improvement of the machining accuracy is desired under a recent circumstance of downsizing progress. For instance, if the machining electrode 100 illustrated in FIG. 2 is used, so called machining in “order of millimeters” can be performed accurately. However, when machining in less than “order of sub-millimeters” (for example, machining in order of micrometers) is performed, further prevention of the broadening of the dielectric flux density is needed.

Next, on returning to FIG. 1, a machining electrode 1 according to this embodiment is illustrated.

As shown in FIG. 1, the machining electrode 1 is provided with a base substance 2, an insulating unit 3 and a shielding unit 4. A cross-sectional shape and cross-sectional dimension of the base substance 2 correspond to a shape and dimension of the patterned portion of the workpiece 104.

The base substance 2 includes an electrolytic portion 2a faced to the workpiece 104 on one end face in an axial direction. The base substance 2 is formed from materials having conductivity. For instance, it can be formed from metal materials or the like. The metal materials are not particularly limited, but materials with a good corrosion resistance are preferably selected in consideration of dipping into the electrolytic solution 105. Such materials can illustratively include platinum, stainless steel or the like. However, the materials are not limited thereto, but can be changed appropriately.

A portion dipped into the electrolytic solution 105, namely, a surface of the base substance 2 other than the electrolytic portion 2a (portion faced to pattern the workpiece 104) is covered with the insulating unit 3 having insulation. That is, the insulating unit 3 having insulation is provided on a face in a direction generally orthogonal to the axial direction of the base substance 2. Materials for the insulating unit 3 are not particularly limited, but can be based on an epoxy based resin, an urethane based resin and a polyimide based resin in consideration of breakdown voltage in the electrochemical machining, the corrosion resistance to the electrolytic solution 105, and a low dielectric constant. However, the materials are not limited thereto, but can be changed appropriately.

Moreover, the shielding unit 4 is provided to cover the insulating unit 3. That is, the shielding unit 4 is provided on a face opposed to a side of the insulating unit 3 provided on the base substance 2. The shielding unit 4 is formed from materials having conductivity, and can be illustratively formed from metal materials. The metal materials are not particularly limited, but materials with a good corrosion resistance are preferably selected in consideration of dipping into the electrolytic solution 105. Such materials can illustratively include platinum, stainless steel or the like. However, the materials are not limited thereto, but can be changed appropriately.

One end of the machining electrode 1 is dipped into the electrolytic solution 105, and the electrolytic portion 2a is faced to the surface of the workpiece 104. An end face on a side opposed to the electrolytic portion 2a of the base substance 2 is electrically connected to the cathode side of the power supply 106 for applying direct current voltage. The anode side of the power supply 106 is electrically connected to the workpiece 104. Voltage can be applied between the machining electrode 1 (base substance 2) and the workpiece 104. Hence, the electrolytic reaction can be caused between the electrolytic portion 2a and the patterned portion of the workpiece 104, and thus the surface of the workpiece 104 can be dissolved electrochemically to be patterned in a desired shape.

The shielding unit 4 is electrically connected to the anode side of the power supply 106. That is, the shielding unit 4 is electrically connected to the workpiece 104. Hence, the potential of the shielding unit 4 is generally the same as that of the workpiece 104.

According to this embodiment, the shielding unit 4 is provided so as to cover the insulating unit 3 and the potential of the shielding unit 4 is set generally the same as that of the workpiece 104, and thus the base substance 2 can be shielded. Therefore, the broadening of the dielectric flux density can be more prevented, and thus the machining accuracy can be further improved.

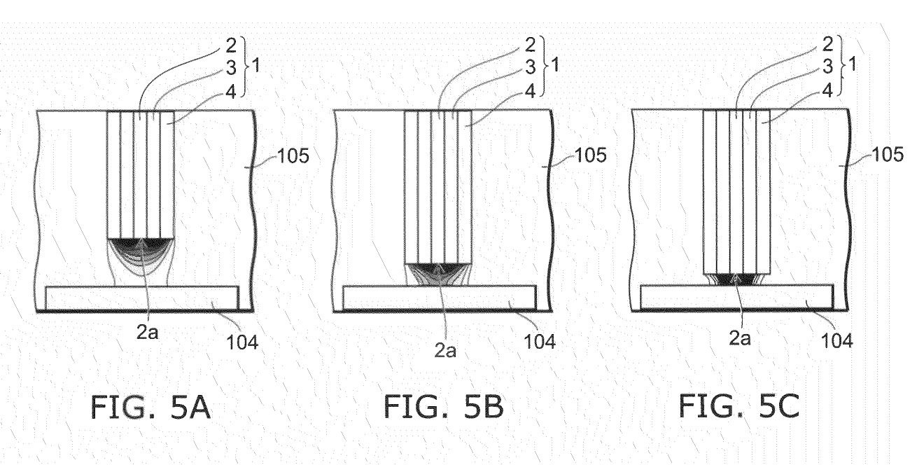

FIGS. 5A to 5C are schematic views for illustrating simulation results on a distribution of dielectric flux density in the machining electrode according to this embodiment. In this case, a diameter of the base substance 2 is set to be 5 mm, a thickness of the insulating unit 3 is set to be 5 mm, and a thickness of the shielding unit 4 is set to be 5 mm. FIGS. 5A, 5B and 5C illustrate cases where the distance between the electrolytic portion 2a and the workpiece 104 is changed, and the distance is set to be 15 mm for FIG. 5A, 10 mm for FIG. 5B, and 5 mm for FIG. 5C. FIGS. 5A to 5C show simulation results of the broadening of the dielectric flux density, its intensity shown by light and shade of a monotone color, and as the dielectric flux density becomes higher, the monotone color becomes denser, and the lower, the lighter.

As shown in FIGS. 5A to 5C, the machining electrode 1 according to this embodiment is used, the broadening of the dielectric flux density can be contained immediately below the machining electrode 1. As shown in FIGS. 5A to 5C, changing the distance between the electrolytic portion 2a and the workpiece 104 can prevent the broadening of the dielectric flux density. Hence, the portion other than the desired portion can be prevented from being dissolved electrochemically, and thus the machining accuracy can be improved.

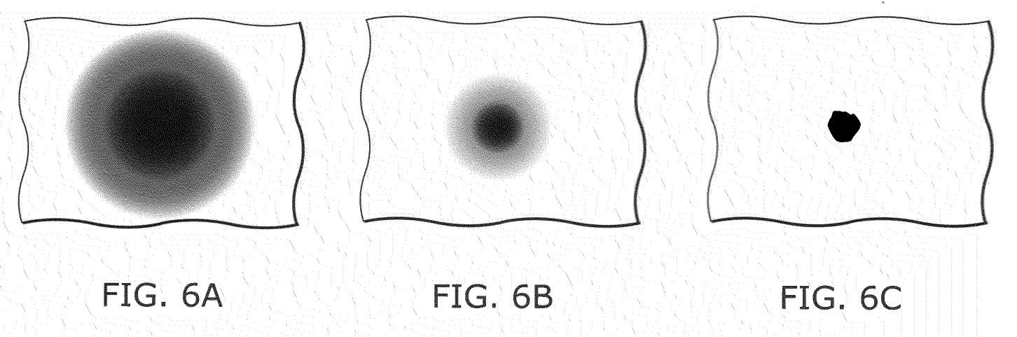

FIGS. 6A to 6C are schematic plan views for illustrating the patterned portion of the workpiece.

In this case, the workpiece is based on a film of Ti (titanium; thickness is 20 nm) and Cu (copper; thickness 0.9 pm) sputtered on a glass substrate. The base substance has a needle-like shape with a diameter of 0.5 mm. The distance between the electrolytic portion of the base substance and the workpiece is set to be 1 mm, and the electrolytic solution is based on an NaOH aqueous solution (sodium hydroxide aqueous solution) of 1 M (mole/litter). Applied voltage is set to be 2 V. The Cu (copper) film is subjected to electrochemical machining for 1 minutes and the Cu film surface is observed with an optical microscope.

FIG. 6A shows the case where the machining electrode made of only the needle-like base substance is used, FIG. 6B shows the case where the machining electrode provided with the insulating unit made of polyethylene with a thickness of 600 μm is used, and FIG. 6C shows the case where the insulating unit in FIG. 6B is further covered with the shielding unit with a thickness of 150 μm, that is, the machining electrode 1 according to this embodiment is used. In this case, the potential of the shielding unit is generally the same as that of the Cu film.

If the machining electrode 1 according to this embodiment is used as shown in FIG. 6C, only a region inside the shielding unit can be processed. That is, if the machining electrode 1 according to this embodiment is used, as shown in FIGS. 6A to 6C, the dimension of the patterned portion of the workpiece can be markedly reduced, even if the base substance having the same diameter is subjected to electrochemical machining. This means that an unintended portion can be prevented from dissolving in machining the workpiece and the machining accuracy can be markedly improved.

As illustrated above, in the machining electrode according to this embodiment, the shielding unit 4 is provided so as to cover the insulating unit 3 and the potential of the shielding unit 4 is set generally the same as that of the workpiece 104, and thus the base substance 2 can be shielded. Therefore, the broadening of the dielectric flux density can be more prevented and the machining accuracy can be further improved.

Next, the electrolytic solution according to this embodiment will be illustrated.

Improving the machining accuracy in the electrochemical machining raises problems such as a contamination on the machining electrode, occurrence of foreign substance between the machining electrode and the workpiece, and the surface condition (so called surface roughening) of the patterned portion.

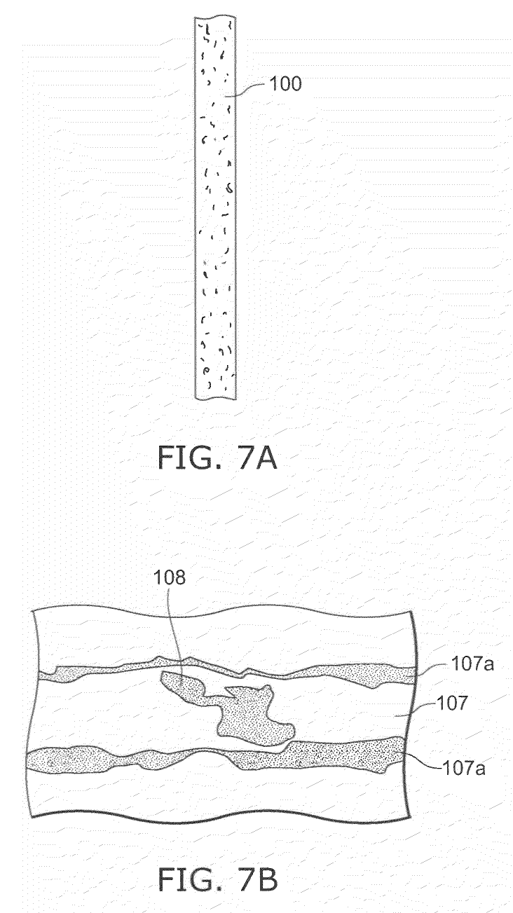

FIGS. 7A and 7B are schematic views for illustrating the contamination on the machining electrode and the surface condition (so called surface roughening) of the patterned portion. FIG. 7A is a schematic view for illustrating the contamination on the machining electrode 100, and FIG. 7B is a schematic plan view of a patterned groove 107. Both of FIGS. 7A and 7B show a Cu film subjected to the electrochemical machining.

As shown in FIG. 7A, after the electrochemical machining, a precipitated substance adheres to the surface of machining electrode 100, and may form the “contamination”. Moreover, not shown in the figure, a precipitated substance occurring between the machining electrode 100 and the workpiece may form the “foreign substance”. The electrochemical machining with this kind of contamination and foreign substance causes a machining speed of electrochemical machining to be nonuniform. As shown in FIG. 7B, a flaggy portion 107a may occur in an angled portion (edge portion) of the patterned portion (“groove” illustrated in FIG. 7B), a rough portion may occur on a side wall of the patterned portion, and a residual substance 108 may occur.

That is, the surface condition of the patterned portion may turn into the condition of surface roughening. The occurrence of this kind of surface roughening may deteriorate the machining accuracy. In the case where the machining accuracy in order of sub-millimeters to micrometers is required, the occurrence of surface roughening may cause a problem. Particularly, in wiring of a flat panel display and machining of a Cu film in a semiconductor device or the like, the high machining accuracy is frequently required and preventing the surface roughening is desired.

As a consequence of investigation, authors acquired findings that in subjecting the workpiece including Cu (copper) such as a Cu film to electrochemical machining, the surface roughening can be prevented by setting a pH (hydrogen ion concentration exponent) of the electrolytic solution to be 8 or more.

For instance, when the Cu film is subjected to electrochemical machining using the electrolytic solution with a pH less than 8, particularly 7 or less, the Cu film being the workpiece is dissolved and removed according to the following equation (1).

Cu=Cu²⁺+2e⁻ (1)

At this time, dissolved Cu ions precipitate as Cu and form the surface contamination or the foreign substance on the machining electrode. The occurrence of the contamination or the foreign substance causes the machining speed of the electrochemical machining to be ununiform and increases fear of the occurrence of the surface roughening and the residual substance.

Here, when the workpiece including Cu (copper) such as a Cu film is subjected to electrochemical machining by using the electrolytic solution with a pH of 8 or more, generation of Cu ions can be prevented. For instance, if the pH (hydrogen ion concentration exponent) of the electrolytic solution is approximately 8 to 12, the generation of Cu ions is prevented and instead results in generation of oxides such as Cu₂O and CuO. Particularly, if the pH is 12 or more, Cu₂O²⁺ comes to be generated. In this case, generation of Cu₂O²⁺ is preferable rather than generation of the oxides such as Cu₂O and CuO. Thus, the pH (hydrogen ion concentration exponent) of the electrolytic solution is preferred to be 12 or more.

The electrolytic solution with such a pH (hydrogen ion concentration exponent) can illustratively include NaOH, KOH, and tetra-methyl-ammonium hydroxide (TMAH) solutions or the like. However, without limitation to these solutions, approximate change to an alkaline solution with a pH of 8 or more is allowed. Here, an alkaline solution with a pH of 12 or more is preferable.

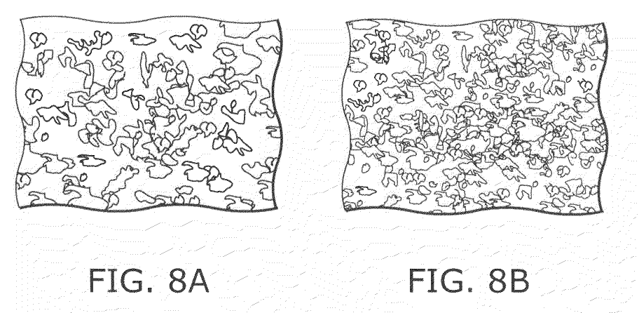

FIGS. 8A and 8B are schematic views for illustrating the surface condition of the patterned portion. Here, FIGS. 8A and 8B are schematic views for illustrating the surface condition of Cu films after the electrochemical machining of 30 seconds. FIG. 8A shows the case where a phosphoric acid solution (approximate pH of 2) of 1 M (mole/liter) is used as the electrolytic solution, and FIG. 8B shows the case where a salt solution (approximate pH of 7) of 1 M (mole/liter) is used.

As shown in FIGS. 8A and 8B, if the electrolytic solution with a pH of less than 8, particularly 7 or less is used, it is found that precipitation of Cu on the surface causes the surface to roughen.

On the other hand, not shown in the figure, it can be confirmed that if the electrolytic solution is based on a sodium hydroxide solution (approximate pH of 13) of 1 M (mole/liter), the precipitation of Cu can be prevented and thus the surface can be smoothed. Moreover, no “contamination” on the electrode surface after the electrochemical machining and no occurrence of “foreign substance” can be confirmed. It can be confirmed that a flaggy portion does not occur at the angled portion (edge portion) of the patterned portion (groove with a width of about 380 μm), and surface roughening on the side wall of the patterned portion and the residual substance or the like do not occur.

As illustrated above, the electrolytic solution according to this embodiment can prevent Cu from precipitating. Hence, the occurrence of contamination on the machining electrode can be prevented, and furthermore the occurrence of foreign substance can also be prevented. As a result, the electrochemical machining speed can be uniformized and the surface roughening can be prevented and thus the machining accuracy can be further improved.

Next, an electrochemical machining apparatus according to this embodiment will be illustrated.

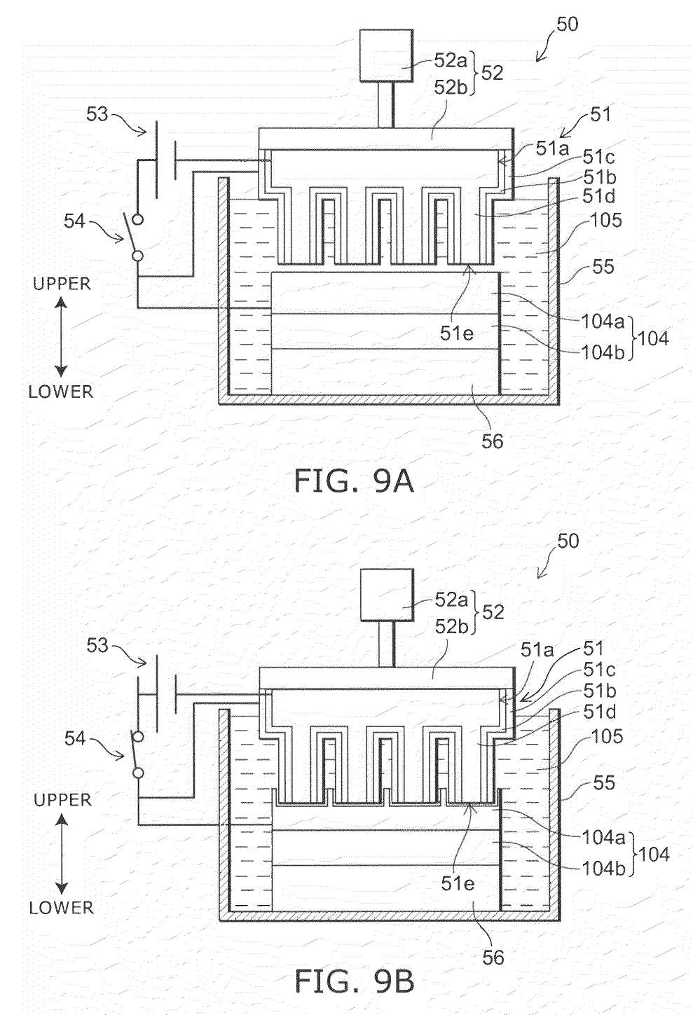

FIGS. 9A and 9B are schematic cross-sectional views for illustrating an electrochemical machining apparatus according to this embodiment. FIG. 9A shows a state before electrochemical machining and FIG. 9B shows a state under electrochemical machining.

As shown in FIGS. 9A and 9B, the electrochemical machining apparatus 50 includes a machining electrode 51, a moving mechanism 52, a power supply 53, a power supply control mechanism 54 and an electrolytic cell 55.

The machining electrode 51 includes a base substance 51a, an insulating unit 51b, and a shielding unit 51c. The base substance 51a includes a plurality of convex portions 51d in accordance with a shape dimension of a patterned portion of the workpiece 104. An end face of the convex portion 51d includes an electrolytic portion 51e (portion faced to pattern the workpiece 104). Moreover, providing a plurality of electrolytic portions 51e allows a pattern shaped machining to be performed in one operation on the surface of the workpiece 104.

The base substance 51a is formed from materials having conductivity, for example, can be formed from metal materials or the like. The metal materials are not particularly limited, but materials with a good corrosion resistance are preferably selected in consideration of dipping into the electrolytic solution 105. Such materials can illustratively include platinum and stainless steel or the like. However, the materials are not limited thereto, but can be changed appropriately.

A portion dipped into the electrolytic solution 105, namely, a surface of the base substance 51a other than the electrolytic portion 51e is covered with the insulating unit 51b having insulation. Materials for the insulating unit 51b are not particularly limited, but can be based on an epoxy based resin, an urethane based resin and a polyimide based resin in consideration of breakdown voltage in the electrochemical machining, the corrosion resistance to the electrolytic solution 105, and a low dielectric constant. However, the materials are not limited thereto, but can be changed appropriately.

Moreover, the shielding unit 51c is provided to cover the insulating unit 51b. The shielding unit 51c is formed from materials having conductivity, and can be illustratively formed from metal materials. The metal materials are not particularly limited, but materials having the good corrosion resistance are preferably selected in consideration of dipping into the electrolytic solution 105. Such materials can illustratively include platinum, stainless steel or the like. However, the materials are not limited thereto, but can be changed appropriately.

The moving mechanism 52 for holding and moving the machining electrode 51 is provided on a face opposed to a face of the base substance 51a where the convex portion 51d is provided. The moving mechanism 52 includes a holding unit 52b for holding the machining electrode and a driving unit 52a for moving the machining electrode 51 via the holding unit 52b. The holding mechanism provided on the holding unit 52b and not shown can illustratively include a mechanical chuck or the like. The driving unit 52a can illustratively include a unit provided with a driving mechanism such as a servomotor and a power transmission mechanism such as a ball screw. Here, the configurations of the driving unit 52a and the holding unit 52b are not limited to illustrated ones, but can be changed appropriately.

A cathode side of the power supply 53 for application of direct current voltage is electrically connected to the base substance 51a. An anode side of the power supply 53 is electrically connected to the workpiece 104 and the shielding unit 51c. That is, the machining electrode 51 is provided with the base substance 51a including a plurality of electrolytic portions 51e faced to the workpiece 104 on one end in the axial direction, the insulating unit 51b provided on a face in the direction generally orthogonal to the axial direction of the base substance 51a and having insulation, and the shielding unit 51c provided on a face opposed to a side of the insulating unit 51b provided on the base substance 51a, and the cathode side of the power supply 53 is electrically connected to the base substance 51a and the anode side of the power supply 53 is electrically connected to the shielding unit 51c and the workpiece 104.

The power supply control mechanism 54 is provided on the anode side of the power supply 53, and ON/OFF control of the applied voltage is possible.

Moreover, a placement stage 56 for placing and holding the workpiece 104 is provided inside the electrolytic cell 55 for storing the electrolytic solution 105. A stage surface of the placement stage 56 is provided so as to oppose to the holding unit 52b of the moving mechanism 52, and the workpiece placed on the placement stage 56 and the machining electrode 51 hold on the holding unit 52b face each other. That is, the machining electrode 51 is provided to oppose to the placement stage 56.

The workpiece 104 can illustratively include a Cu film 104a formed on a major surface of a glass substrate 104b. In this case, the Cu film 104a is a target to be patterned, the electrochemical machining is performed on its surface with a prescribed shape and dimension. The target to be patterned is not limited to be made of Cu, but is arbitrary as long as it is formed from materials capable of being anodized.

The electrolytic solution 105 is not particularly limited, but when the target to be patterned includes Cu (copper) such as a Cu (copper) film, it is preferred to be the electrolytic solution 105 with a pH (hydrogen ion concentration exponent) of 8 or more.

The electrolytic solution with such a pH (hydrogen ion concentration exponent) can illustratively include NaOH, KOH, and tetra-methyl-ammonium hydroxide (TMAH) solutions or the like. However, without limitation to these solutions, approximate change to an alkaline solution with a pH of 8 or more is allowed. Here, as described above, it is preferable to be a pH of 12 or more.

A supply mechanism for supplying the electrolytic solution 105 and a temperature control mechanism for controlling the temperature of the electrolytic solution 105, both of them are not shown, can be appropriately provided. As illustratively shown in FIGS. 9A and 9B, the electrolytic solution 105 is stored in the electrolytic cell 55, and the machining electrode 51 and the workpiece 104 are dipped into the electrolytic solution 105, but the illustration is not limited to this. For example, the electrolytic solution 105 may be supplied so as to fill between the machining electrode 51 and the workpiece 104 with the electrolytic solution 105.

Next, an operation of the electrochemical machining apparatus 50 is illustrated and an electrochemical machining method according to this embodiment is illustrated.

First, the workpiece 104 is carried into by a transfer apparatus not shown, and placed and hold on the stage surface of the placement stage 56. At the time of placement of the workpiece 104 on the placement stage 56, the Cu film 104a (target to be patterned) of the workpiece 104 is electrically connected to the anode side of the power supply 53.

Next, the electrolytic solution 105 is supplied inside the electrolytic cell 55 from the supply mechanism not shown. A prescribed distance between the electrolytic portion 51e of the machining electrode 51 and the Cu film 104a is kept by moving the machining electrode 51 downward in the figure using the moving mechanism 52. Here, the electrolytic solution 105 is supplied after the placement of the workpiece 104, but the workpiece 104 may be carried into and placed after the electrolytic solution 105 is supplied and stored.

Next, the direct current voltage is applied between the base substance 51a of the machining electrode 51 and the Cu film 104a (target to be patterned) by closing a power circuit using the power supply control mechanism 54. The electrolytic reaction is caused between the electrolytic portion 51e and the Cu film 104a (target to be patterned), and thus the surface of the Cu film 104a (target to be patterned) is electrochemically dissolved. The machining electrode 51 is moved downward in the figure by the moving mechanism, and thus the electrochemical machining is performed so that the prescribed depth is obtained. In this case, the shielding unit 51c and the Cu film 104a (target to be patterned) are electrically connected to the anode side of the power supply 53, hence generally the same potential can be applied to both of them.

When the prescribed electrochemical machining ends, the machining electrode 51 is moved upward in the figure using the moving mechanism 52, and the workpiece 104 is carried out using the transfer apparatus not shown.

That is, the electrochemical machining method according to this embodiment is an electrochemical machining method where the electrolytic reaction is caused by applying voltage between the machining electrode 51 and the workpiece 104 to dissolve the surface of the workpiece 104 electrochemically. The machining electrode 51 is provided with the base substance 51a including the electrolytic portions 51e faced to the workpiece 104 on one end in the axial direction, the insulating unit 51b provided on a face in the direction generally orthogonal to the axial direction of the base substance 51a and having insulation, and the shielding unit 51c provided on a face opposed to a side of the insulating unit 51b provided on the base substance 51a, and the potential of the workpiece 104 is generally the same as that of the shielding unit 51c.

When the target to be patterned includes Cu (copper) such as a Cu (copper) film, it is decided that the electrolytic solution 105 with a pH (hydrogen ion concentration exponent) of 8 or more is used.

According to this embodiment, the potential of the shielding unit 51c provided on the machining electrode 51 is generally the same as that of the Cu film 104a (target to be processed), hence the base substance 51a can be shielded. Therefore, the broadening of the dielectric flux density can be more prevented. As a result, unintended dissolution in a direction generally orthogonal to the machining direction is prevented, and thus machining with high anisotropy can be performed. This means that the machining accuracy can be further improved.

When the target to be patterned is formed from Cu, using the electrolytic solution 105 of a pH (hydrogen ion concentration exponent) of 8 or more can prevent occurrence of the contamination on the machining electrode 51 and occurrence of the foreign substance. As a result, the electrochemical machining speed can be homogenized and the surface roughening can be prevented, and thus the machining accuracy can be further improved.

The machining electrode 51 including a plurality of electrolytic portions 51e (portion faced to pattern the workpiece 104) is used, and hence the pattern shaped machining can be performed in one operation. Here, the shape of the machining electrode is not limited to the shape shown in the figure, but can be changed appropriately. For example, the machining electrode illustrated in FIG. 1 can be used.

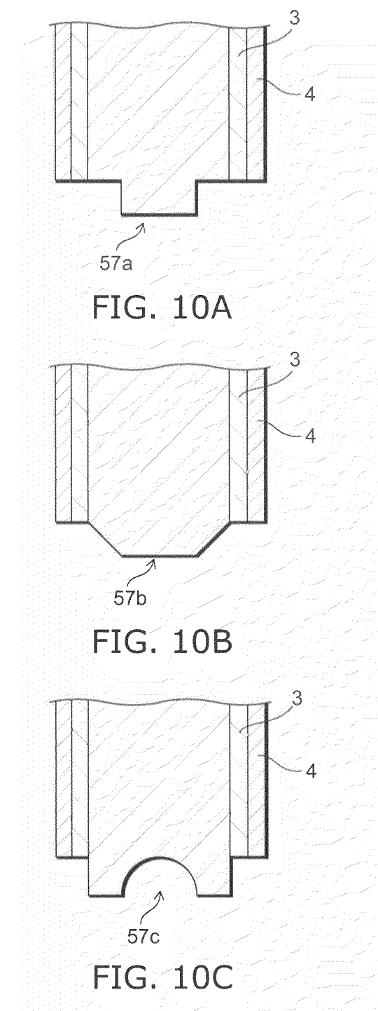

In FIG. 1 and FIGS. 9A and 9B, the planate electrolytic portion is illustrated, but the electrolytic portion is not limited thereto. For example, convex electrolytic portions 57a, 57b illustrated in FIGS. 10a and 10B, a concave electrolytic portion 57c illustrated in FIG. 10C can also be used. Here, a shape of the electrolytic portion is not limited to the illustrated shape, but can be changed appropriately. For example, a shape formed from an optional curve or straight line can be selected appropriately.

Next, a method for manufacturing a structure body according to this embodiment will be illustrated.

The structure body can illustratively include one having unevenness on the surface. For example, a print circuit board, a wiring portion such as a flat panel display, a photo-mask, a semiconductor device, and a mechanical component such as a dynamical pressure bearing of a hard disk driving device can be illustrated.

Here, a manufacturing method of the flat panel display is exemplified. The flat panel display can illustratively include a thin film transistor driving liquid crystal display (TFT-LCD), a plasma display (PD), a field emission display (FED), and an organic EL display or the like. The machining electrode, the electrolytic solution, the electrochemical machining apparatus, and the electrochemical machining method according to the above embodiment can be used in a forming process of wiring portions of these flat panel displays.

Generally, a wet etching and a dry etching are used for forming wiring portions of the flat panel displays.

The wet etching is a simple and low-cost machining method, but suffers from difficulty of fine patterning due to isotropic etching. On the other hand, using the dry etching represented by RIE (reactive ion etching) allows highly anisotropic patterning to be performed with suppression of side etching. Hence, the fine patterning with high machining accuracy can be performed. However, the dry etching causes problems of a high cost of an apparatus and of inability to a large etching ratio of a film to be etched to a foundation film and a resist.

Consequently, in the method for manufacturing the structure body according to this embodiment, the wiring portion is formed by the machining electrode, the electrolytic solution, the electrochemical machining apparatus and the electrochemical machining method according to this embodiment described above in stead of the wet etching and dry etching. Here, already known techniques for processes can be applied other than the machining electrode, the electrolytic solution, the electrochemical machining apparatus and the electrochemical machining method according to this embodiment described above, and hence a description is omitted.

According to this embodiment, the wiring portion having high machining accuracy can be formed with a low cost. Moreover, a product yield can be improved and productivity can also be improved.

Here, by way of example, the manufacturing method of the flat panel display is exemplified, but this embodiment is not limited thereto.

This embodiment is illustrated above. However, the invention is not limited thereto.

Any addition of design change in the above embodiments suitably made by those skilled in the art are also encompassed within the scope of the invention as long as they fall within the feature of the invention.

For example, a shape, a dimension, a material and arrangement or the like of each element included in the aforementioned machining electrode and electrochemical machining apparatus or the like are not limited to illustrated ones, but can be changed appropriately. Moreover, composition of the electrolytic solution is also not limited to illustrated one, but can be changed appropriately.

Each element included in each embodiment can be combined to the extent possible, and these combinations are also encompassed within the scope of the invention as long as they include the feature of the invention.

1. A machining electrode comprising:
a base substance including an electrolytic portion faced to a workpiece on one end face in an axial direction and having conductivity;
an insulating unit provided on a face in a direction generally orthogonal to the axial direction of the base substance and having insulation; and
a shielding unit provided on a face opposite to the base substance of the insulating unit.

2. The electrode according to claim 1, wherein the shielding unit is electrically connected to the workpiece.

3. The electrode according to claim 1, wherein
the base substance is electrically connected to a cathode side of a power supply, and
the shielding unit is electrically connected to an anode side of the power supply.

4. The electrode according to claim 1, wherein potential of the workpiece is generally the same as that of the shielding unit to shield the base substance.

5. The electrode according to claim 1, wherein a plurality of the electrolytic portions are provided.

6. An electrochemical machining apparatus comprising:
a power supply;
an electrolytic cell configured to store an electrolytic solution;
a placement stage provided inside the electrolytic cell and configured to place the workpiece;
a machining electrode provided opposed to the placement stage, the machining electrode including:
a base substance including an electrolytic portion faced to a workpiece on one end face in an axial direction and having conductivity;
an insulating unit provided on a face in a direction generally orthogonal to the axial direction of the base substance and having insulation; and
a shielding unit provided on a face opposite to the base substance of the insulating unit; and
a moving mechanism configured to move the machining electrode.

7. The apparatus according to claim 6, wherein
a cathode side of the power supply is electrically connected to the base substance, and
an anode side of the power supply is electrically connected to the shielding unit and the workpiece.

8. The apparatus according to claim 6, wherein the electrolytic cell stores an electrolytic solution having a hydrogen ion concentration exponent, a pH of 8 or more.

9. The apparatus according to claim 6, wherein a power supply control mechanism configured to control applied voltage is further provided on the anode side of the power supply.

10. The apparatus according to claim 6, wherein a supply mechanism configured to supply the electrolytic solution is further provided inside the electrolytic cell.

11. The apparatus according to claim 6, wherein a temperature control mechanism configured to control a temperature of the electrolytic solution is further provided.

12. An electrochemical machining method, comprising causing an electrolytic reaction by applying voltage between a machining electrode and a workpiece in an electrolytic solution, and machining a surface of the workpiece,
the machining electrode being provided with a base substance including an electrolytic portion faced to the workpiece on one end face in an axial direction, an insulating unit provided on a face in a direction generally orthogonal to the axial direction of the base substance and having insulation, and a shielding unit provided on a face opposite to the base substance of the insulating unit, and
potential of the workpiece and the shielding unit being generally the same.

13. The method according to claim 12, wherein the workpiece includes Cu (copper).

14. The method according to claim 12, wherein a hydrogen ion concentration exponent, a pH of the electrolytic solution is 8 or more.

15. The method according to claim 12, wherein broadening of a dielectric flux density is controlled by changing a distance between the electrolytic portion and the workpiece.

16. The method according to claim 12, wherein negative voltage is applied to the base substance, and positive voltage is applied to the workpiece and the shielding unit.

17. The method according to claim 12, wherein the electrolytic solution is supplied so as to fill between the machining electrode and the workpiece with the electrolytic solution.

18. The method according to claim 12, wherein the electrolytic solution is a solution including at least one selected from a group consisting of NaOH, KOH, and tetra-methyl-ammonium hydroxide (TMAH).

19. A method for manufacturing a structure body, comprising forming unevenness on a workpiece using a electrochemical machining method, the electrochemical machining method including:
causing an electrolytic reaction by applying voltage between a machining electrode and a workpiece in an electrolytic solution, and machining a surface of the workpiece,
the machining electrode being provided with a base substance including an electrolytic portion faced to the workpiece on one end face in an axial direction, an insulating unit provided on a face in a direction generally orthogonal to the axial direction of the base substance and having insulation, and a shielding unit provided on a face opposite to the base substance of the insulating unit, and
potential of the workpiece and the shielding unit being generally the same.

20. The method according to claim 19, wherein the workpiece is at least one selected from a group consisting of a print circuit board, a flat panel display, a photo mask, a semiconductor device, and a dynamical pressure bearing of a hard disk driving device.
